(19) United States
(12) Patent Application Publication
(10) Pub. No.: US 2024/0253367 A1
(43) Pub. Date: Aug. 1, 2024

(54) INSTALLATION FOR DECORATING HOLLOW GLASS OBJECTS COMPRISING A CONVEYOR FOR SCROLLING THE OBJECTS PAST AT LEAST ONE DIGITAL PRINTING STATION

(71) Applicant: POCHET DU COURVAL, CLICHY (FR)

(72) Inventors: ANTOINE DELDIN, YAUCOURT-BUSSUS (FR); ROMUALD GUILBAUT, DRUCAT (FR)

(21) Appl. No.: 18/426,742

(22) Filed: Jan. 30, 2024

(30) Foreign Application Priority Data
Jan. 30, 2023 (FR) 23 00834

(51) Int. Cl. B41J 11/00; B41J 3/407; B41J 3/42; B41M 5/00; B65B 61/02; B65G 15/28

(52) U.S. Cl. CPC B41J 11/007; B41J 3/40733; B41J 3/42; B41J 11/002; B41J 11/0095; B41M 5/0011; B41M 5/007; B41M 5/0088; B65B 61/025; B65G 15/28

(57) ABSTRACT

An installation (10) for decorating a plurality of hollow objects (12) of glass, metal or plastic material, in particular perfume bottles or packaging, comprising:
a frame (20),
a conveyor (22) suitable for moving the objects successively along a trajectory (T) with respect to the frame,
at least one printing station (24A) suitable for producing a digital printing of at least a portion of decoration on each of the objects.

The conveyor is further suitable for moving each of the objects successively past the printing station during the digital printing.

### BACKGROUND OF THE INVENTION

### Field of the Invention

The present invention relates to an installation for decorating a plurality of hollow glass objects, in particular perfume bottles, comprising:
a frame
a conveyor suitable for moving objects with respect to the frame,
at least one printing station attached to the frame and suitable for performing a printing of at least a portion of the decoration on each of the objects.

### Description of Related Art

The present invention further relates to a corresponding decoration method.

In the field of decoration of hollow glass objects, it is known how to print one or a plurality of portions of decoration, corresponding e.g. to primary colors, by means of screen printing or of pad printing stations. Such techniques serve to deposit one or a plurality of layers of ink on the surface, either flat or curved, of each of the objects.

A conveyor is used to successively bring objects close to the printing station(s). Then, in order to ensure a sufficiently precise positioning of the decoration on the objects, each of the objects is transferred onto an object holder, generally a base-tip system, which allows the object to be presented and oriented precisely with respect to a printing station. After printing, in general, each of the objects is transferred back to a conveyor that moves the object away from the printing station(s).

Such way of decorating the objects gives satisfaction from the point of view of the quality of the decoration but requires a quite bulky and hence expensive decoration installation.

A goal of the invention is to propose an installation for decorating hollow glass objects which is less bulky and less expensive than the current installations, while maintaining an unchanged quality of decoration for a user of the decorated object.

### BRIEF SUMMARY OF THE INVENTION

To this end, the invention relates to an installation for decorating a plurality of hollow objects made of glass, metal or plastic, in particular perfume bottles or packaging, comprising:
a frame,
a conveyor suitable for moving the objects successively along a trajectory with respect to the frame,
at least one printing station suitable for performing a digital printing of at least a portion of decoration on each of the objects, wherein the conveyor is further suitable for moving each of the objects successively past the printing station during the digital printing.

According to particular embodiments, the installation has one or a plurality of the following features, taken individually or according to all technically possible combinations:
the installation comprises a plurality of printing stations suitable for performing digital printings of portions of decoration on each of the objects, the conveyor being suitable for moving the objects past each of the printing stations during the digital printings;
the installation comprises: at least one presence detector suitable for detecting objects, the conveyor being suitable for moving objects successively past the presence detector before moving the objects past the printing station, the presence detector being suitable for generating a detection signal; and a control system suitable for receiving the detection signal and for sending a synchronization signal to the printing station;
the installation comprises at least one pre-treatment station suitable for carrying out a pre-treatment of the objects, the conveyor being further suitable for moving the objects successively past the pre-treatment station before moving the objects past the printing station;
the installation comprises at least one post-treatment station suitable for carrying out a final or intermediate curing of each of the objects, the conveyor being further suitable for moving the objects successively past the post-treatment station;
the conveyor is configured to move each of the objects in straight and uniform translation with respect to the frame, at least during digital printing;
the conveyor is configured so that each of the objects is at a distance from the printing station during digital printing, the distance being comprised between 0.1 and 3.0 mm;
the distance is comprised between 0.5 and 1.5 mm; and
the printing station comprises a printing head having one or a plurality of rows of nozzles with ejection ports located in a vertical plane, the row or rows being vertical.

A further subject matter of the invention is a method of decorating a plurality of hollow glass objects, in particular perfume bottles, comprising the following steps:
obtaining an installation as described hereinabove,
moving objects, with the conveyor, with respect to the frame, successively along the trajectory, and
digital printing by the printing station on each of the objects in order to obtain at least a portion of decoration on each of the objects, the conveyor successively moving each of the objects past the printing station during digital printing.

The invention will be better understood upon reading the following description, given only as an example and making reference to the enclosed drawings, wherein:

### BRIEF DESCRIPTION OF THE SEVERAL VIEWS OF THE DRAWING(S)

FIG. 1 is a schematic representation of an installation according to the invention, and

FIG. 2 is a top view of the installation represented in FIG. 1.

### DETAILED DESCRIPTION OF THE INVENTION

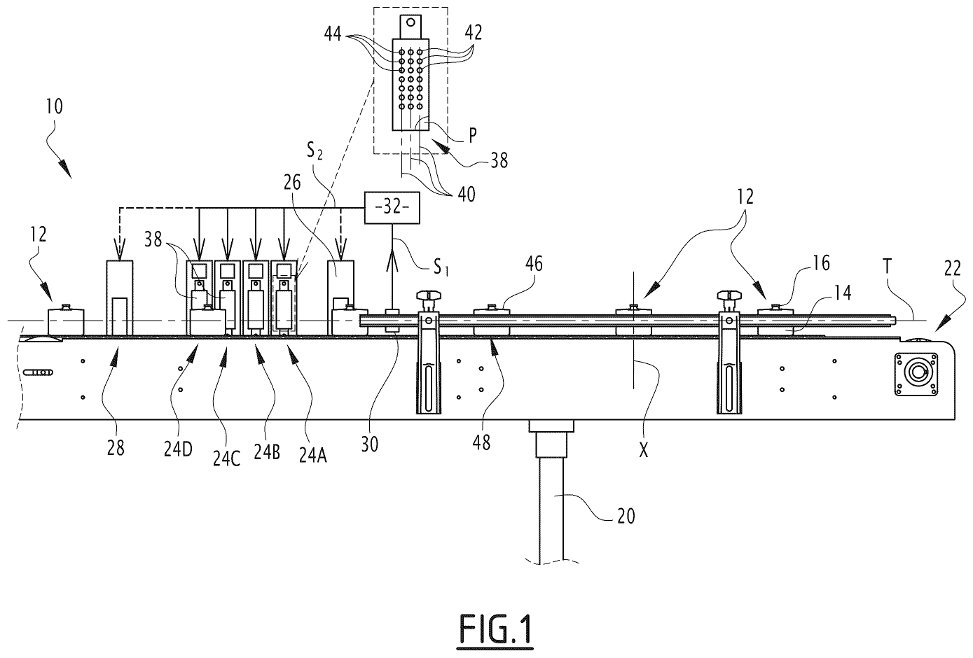

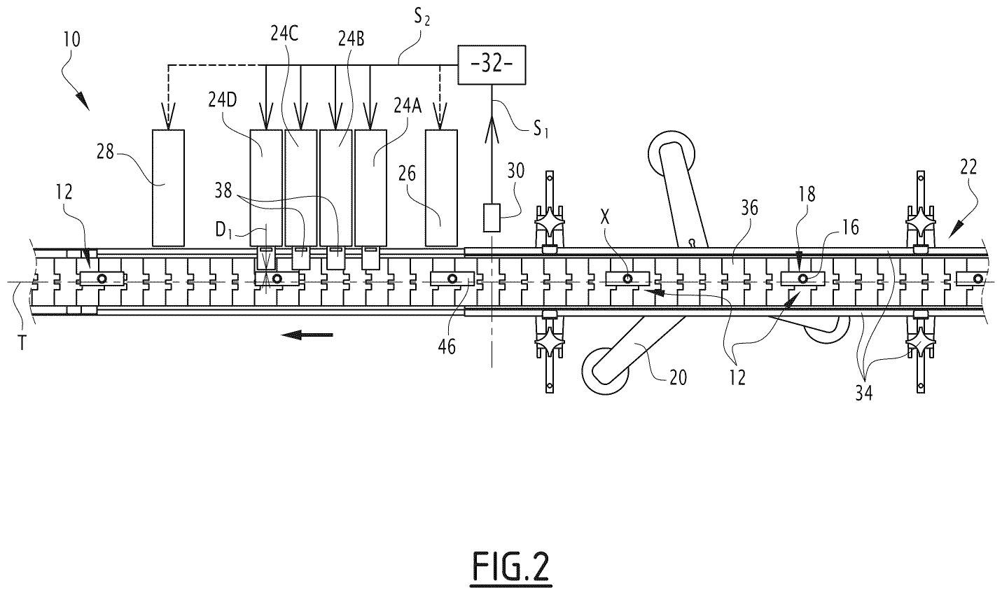

An installation 10 according to the invention, is described with reference to FIGS. 1 and 2.

The installation 10 is suitable for decorating a plurality of hollow glass objects 12, e.g. bottles intended for perfume.

According to variants that are not shown, the objects 12 are e.g. made of metal or plastic. The objects 12 are e.g. packages intended to contain bottles.

The objects 12 are advantageously analog to each other. The objects 12 comprise e.g. a body 14 surmounted by a ring 16.

The body 14 defines at least one surface 18 to be printed, e.g. flat or curved.

In the example, the surface 18 to be printed is a lateral surface with respect to an axis X of each of the objects 12, the axis X passing through the ring 16 and being intended to be vertical in a position for storing the objects on a horizontal surface.

The installation 10 comprises a frame 20 and a conveyor 22 suitable for moving the objects 12 successively along a trajectory T with respect to the frame.

In the example, the installation 10 comprises a plurality of printing stations 24A, 24B, 24C, 24D, e.g. attached onto the frame 20, and suitable for producing digital prints of portions of decoration on each of the objects 12, advantageously in four-color printing, e.g. by depositing cyan, magenta, yellow and white and/or black inks. The number of print stations is four in the example.

According to variants that are not shown, the installation 10 comprises a different number of printing stations, e.g. only one, two, three or more than four.

According to a particular embodiment (not shown), the installation 10 comprises six printing stations, for depositing an adhesion primer, and the colors white, cyan, magenta, yellow and black, all the inks being sensitive to UV.

The installation 10 comprises e.g. a pre-treatment station 26 e.g attached to the frame 20, and suitable for carrying out a pre-treatment of the objects 12, i.e. before the digital print or prints. The pre-treatment uses e.g. a rotary plasma, a Pyrosil® flame treatment, a near infrared lamp (NIR) lamp and/or an indirect discharge Corona® treatment.

In a variant (not shown), the installation 10 comprises a plurality of pre-treatment stations.

The installation 10 advantageously comprises at least one post-treatment station 28, e.g. a UV-curing station suitable for carrying out a final curing of each of the objects 12.

In a variant or in addition, the installation 10 advantageously comprises one or a plurality of UV curing stations suitable for carrying out one or a plurality of intermediate curing stations after each or some of the digital prints.

According to yet other variants, one or a plurality of the curing operations are carried out by radiant stations (not shown).

The installation 10 advantageously comprises at least one presence detector 30 attached to the frame 20, for detecting a passage of the objects 12, and a control system 32 suitable for receiving a detection signal S1 generated by the presence detector, and for sending synchronization signals S2 at least to the printing stations 24A . . . 24D, and, if appropriate, to the other stations 26, 28.

Advantageously, the installation 10 comprises an adjustable guide system 34 suitable for guiding and orienting the objects 12.

If appropriate, the installation 10 comprises protection elements (not shown) intended to prevent the intrusion of unforeseen objects or persons into the installation 10.

The conveyor 22 is suitable for moving discrete and three-dimensional objects (having a minimum thickness, e.g. of at least 2 cm), and not continuous or elongated objects along the trajectory T.

The conveyor 22 comprises e.g. a horizontal conveyor belt 36 on which the objects 12 are placed, the axis X being substantially vertical.

In a variant (not shown), the conveyor 22 comprises e.g. cups wherein the objects 12 are placed.

The conveyor 22 is suitable for successively moving each of the objects 12 past the printing stations 24A . . . 24D during digital printing. In other words, the conveyor 22 brings the objects 12 close to the printing stations 24A . . . 24D and the objects remain on the conveyor during the digital printing(s). The objects 12 are not transferred to object-holders which would present the objects to the printing stations 24A-24D.

In the example, the conveyor 22 is also suitable for successively moving the objects 12 past the presence detector 30 and past the pre-treatment station 26 before moving the objects past the printing stations. The conveyor 22 is advantageously suitable for successively moving the objects 12 past the UV post-treatment station 28 (or, in a variant, past intermediate curing stations).

The conveyor 22 is advantageously configured to move each of the objects 12 in rectilinear and uniform translation with respect to the frame 20, at least during the digital printing.

Advantageously, the conveyor 22 is configured so that each of the objects 12 is at a distance D1 from the printing stations 24A . . . 24D during the digital printing, the distance D1 being comprised e.g. between 0.1 and 3.0 mm, preferentially between 0.5 and 1.5 mm. Depending on the shape of the surface 18 to be printed, the distance D1 may nevertheless vary during the digital printing, advantageously within the aforementioned ranges.

Each of the printing stations 24A . . . 24D comprises a print head 38 including one or a plurality of rows 40 of nozzles 42 having ink ejection ports 44 situated in a plane P, advantageously vertical, the rows being e.g. vertical.

According to variants (not shown), suitable for objects 12 with different shapes (not shown) from the shape shown in FIGS. 1 and 2, and/or for objects 12 having different orientations (not shown) with respect to the frame 20, the plane P not being vertical. For example, the plane P can be substantially horizontal in order to print objects 12 on shoulders 46 or on a bottom 48 (opposite the ring 16 along the axis X). According to another example, the plane P is inclined in order to print objects 12 on an inclined surface (not shown).

The print heads 38 are e.g. models from the Ricoh company, suitable for printing predefined images with a native resolution of 600 DPI (Dot per inch), serving to print up to 1200 DPI.

The printing stations 24A . . . 24D are, e.g., arranged on a common plate (not shown) attached to the frame 20.

The pre-treatment station 26 and the post-treatment station 28 advantageously have a vertical configuration, suitable for treating the surface 18 to be printed, which in the example is substantially vertical.

According to a particular embodiment, the or at least one of the post-treatment stations is suitable for depositing a protective or finishing layer (not shown) on the objects 12. For example, the deposition is carried out using a print head or by spraying.

The operation of the installation 10 follows from the structure thereof and will now be briefly described. The operation illustrates a method according to the invention.

The objects 12 are moved, by the conveyor 22, with respect to the frame 20, successively along the trajectory T. In the example, by means of the conveyor 22, the objects 12 are successively scrolled past the pre-treatment station 26, the presence detector 30, the printing stations 24A . . . 24D and the post-treatment station 28.

A pre-treatment is advantageously carried out by the pre-treatment station 26.

In the example, digital prints are produced by the printing stations 24A-24D, which are advantageously ink-jet printing stations.

A post-treatment is advantageously carried out by the post-treatment station 28.

In the example, the presence detector 30 advantageously detects the passage of each of the objects 12 past same, on the conveyor 22 and generates the detection signal S1 representative of the passage of an object 12.

The detection signal S1 is received by the control system 32, which sends the synchronization signals S2 at least to the printing stations 24A . . . 24D.

The printing stations 24A-24D receive the synchronization signals S2 and start e.g. the digital printing at times corresponding to the beginning of the passage of one of the objects 12 past same, and for a period of time taking into account the speed of movement of the object with respect to the frame 20 and the dimensions of the decoration to be printed (not shown).

By means of the above features, in particular the conveyor 22 moving the objects 12 past the printing station or stations 24A . . . 24D, the installation 10 does not require any object-holder and is less bulky and less expensive than the current installations.

Surprisingly, despite the impression on a moving object, the surface of which is not necessarily flat, the quality of the decoration, both in the resistance and the aesthetics thereof, is maintained for a user of the decorated object.

### Example

The objects 12 are glass bottles.

The objects 12 were advantageously degreased with isopropanol and underwent flame treatment with Pyrosil®.

The bonding primer was e.g. a primer sprayed with silane.

The cyan, magenta, yellow, white and black inks used are known per se for digital printing.

The digital prints were produced at a speed of movement of the objects 12 of 20 cm/s. The printing was done vertically (P-plane vertical), with a Ricoh standard waveform.

The sizes of the drops ejected by the printing stations were 7 pl, 14 pl, or 21 pl, depending on the coverage of the desired decoration, conditioning the thickness thereof.

The UV curing station emits at a wavelength of 365 nm, at a power of 10 W and over a width (in the example, a height) of 75 mm.

A 5.4 kW NIR lamp was used after printing and after UV curing.

The ambient temperature was comprised between 26.2 and 27.6° C., and the relative humidity of the air between 64 and 67%. The ambient humidity was comprised between 13 and 15 g of water per kg of air.

Test images were printed on the 18 surface in the conventional orientation thereof, as well as rotated at 90° on the surface to be printed compared to the conventional orientation.

The quality of the rendering was little affected by the direction of printing.

By increasing the size of the drops, the color rendering was more contrasted, while preserving the sharpness of the patterns.

Up to a distance D1 of 3 mm, the print quality was close to the optimal quality obtained for D1 equal to about 1 mm. Beyond 3 mm, the quality of the patterns was degraded, but could be suitable for some decorations.

1. An installation for decorating a plurality of hollow objects of glass, metal or plastic material, comprising:
a frame,
a conveyor suitable for moving the objects successively along a trajectory with respect to the frame,
at least one printing station suitable for performing a digital printing of at least a portion of decoration on each of the objects,
wherein the conveyor is further suitable for moving each of the objects successively past the printing station during the digital printing.

2. The installation according to claim 1, comprising a plurality of printing stations suitable for performing digital printings of portions of decoration on each of the objects, the conveyor being suitable for moving the objects past each of the printing stations during the digital printings.

3. The installation according to claim 1, comprising:
at least one presence detector suitable for detecting the objects, the conveyor being suitable for moving the objects successively past the presence detector before moving the objects past the printing station, the presence detector being suitable for generating a detection signal, and
a control system suitable for receiving the detection signal and for sending a synchronization signal to the printing station.

4. The installation according to claim 1, comprising at least one pre-treatment station suitable for carrying out a pre-treatment of the objects, the conveyor being further suitable for moving the objects successively past the pre-treatment station before moving the objects past the printing station.

5. The installation according to claim 1, comprising at least one post-treatment station suitable for carrying out a final or intermediate curing of each of the objects, the conveyor being further suitable for successively moving the objects past the post-treatment station.

6. The installation according to claim 1, wherein the conveyor is configured to move each of the objects in rectilinear and uniform translation with respect to the frame, at least during the digital printing.

7. The installation according to claim 1, wherein the conveyor is configured so that each of the objects is at a distance from the printing station during the digital printing, the distance being comprised between 0.1 and 3.0 mm.

8. The installation according to claim 7, wherein the distance is comprised between 0.5 and 1.5 mm.

9. The installation according to claim 1, wherein the printing station comprises a print head having one or a plurality of rows of nozzles having ejection ports located in a vertical plane, the row or rows being vertical.

10. The installation according to claim 1, wherein the objects are perfume bottles or packaging.

11. A method for decorating a plurality of hollow glass objects comprising:
obtaining an installation according to claim 1,
moving the objects, by the conveyor, with respect to the frame, successively along the trajectory,
digital printing, by the printing station, on each of the objects in order to obtain at least a portion of decoration on each of the objects, the conveyor successively moving each of the objects past the printing station during the digital printing.

12. The method of claim 11, wherein the hollow glass objects are perfume bottles.
